(19) United States
(12) Patent Application Publication
(10) Pub. No.: US 2023/0421379 A1
(43) Pub. Date: Dec. 28, 2023

(54) FACE AUTHENTICATION TERMINAL, FACE AUTHENTICATION SYSTEM, AND FACE AUTHENTICATION METHOD

(71) Applicant: Hitachi-LG Data Storage, Inc., Tokyo (JP)

(72) Inventors: Yuichi MATSUI, Tokyo (JP); Norimoto ICHIKAWA, Tokyo (JP)

(21) Appl. No.: 18/138,188

(22) Filed: Apr. 24, 2023

(30) Foreign Application Priority Data
Jun. 24, 2022 (JP) 2022-102270

(51) Int. Cl. H04L 9/32; H04L 9/08

(52) U.S. Cl. CPC H04L 9/3231; H04L 9/0866

(57) ABSTRACT

A face authentication terminal generates a first biometric secret key from a face image of a person captured at a first timing when the person is detected by at least one of a camera and a thermal sensor. The face authentication terminal generates a second biometric secret key from the face image of the person captured at a second timing different from the first timing, generates a biometric public key based on the second biometric secret key, and sends the biometric public key to an authentication server to request biometric public key registration. The authentication server verifies whether the authentication is successful or not using the first biometric secret key and the biometric public key sent to the authentication server, and when the authentication is verified to be successful, the biometric public key registration is completed.

### CROSS-REFERENCE TO RELATED APPLICATION

The present application claims priority from Japanese application JP2022-102270, filed on Jun. 24, 2022, the contents of which is hereby incorporated by reference into this application.

### BACKGROUND OF THE INVENTION

### 1. Field of the Invention

The present invention relates to a face authentication terminal, a face authentication system, and a face authentication method.

### 2. Description of the Related Art

Authentication technologies using biometric information are utilized in various fields. For example, Japanese Unexamined Patent Application Publication No. 2008-158681 discloses a biometric authentication system that encrypts biometric information and uses the encrypted biometric information for authentication.

Japanese Unexamined Patent Application Publication No. 2002-149611 discloses an authentication system that authenticates using possessions. In this authentication system, when a cryptographic key for authentication request is input to the possession, the cryptographic key and the public key are combined, the cryptographic information is calculated from the biometric information and the variation information, and is sent to a verification section as presentation information. In the verification section, the cryptographic information is decoded using the cryptographic key for authentication and the public key, and the information is verified. In the verification section, it is determined whether the decoded biometric information and the registered biometric information match or not, and authentication is completed.

The inventors are considering a face authentication system (a face authentication terminal) using the known Public Biometrics Infrastructure (PBI). The PBI system generates a PBI template (also called a “public template”), which is difficult to restore to the original biometric information, by performing a unidirectional transformation of the biometric information embedded with a secret key, and then generates the PBI template. The PBI template is a personal authentication infrastructure that uses the PBI template to achieve authentication, signature, and encryption.

This face authentication system acquires a face image (face information) by capturing the user's face with the camera of the face authentication terminal. The face authentication system acquires data indicating facial features extracted (generated) based on the face image (hereinafter referred to as “facial feature information”). The facial feature information is used like a secret key for authentication. Since the facial feature information is used like the secret key in this specification, it is also referred to as the “biometric secret key” for convenience.

In this face authentication system, at the time of registration, the face authentication terminal generates (extracts) the facial feature information (the biometric secret key) based on the face image captured by the camera of the user to be registered, creates/generates a secret key and a public key using existing encryption technology, and registers the information generated by embedding the secret key in the facial feature information (biometric secret key) and performing a one-way transformation (the PBI template) and the public key with the authentication server. The PBI template and the public key may also be referred to as the “biometric public key” or the “PBI public key” for convenience. After registration, the biometric secret key and the biometric public key are discarded from the face authentication terminal.

In this face authentication system, during authentication, the face authentication terminal acquires a face image by capturing a face of the user to be authenticated with a camera, generates a biometric secret key based on the face image, and the authentication server performs authentication using the biometric secret key and the registered biometric public key. The biometric secret key (facial feature information) is discarded from the face authentication terminal after authentication. The face authentication terminal may also perform authentication.

In this face authentication system (face authentication terminal), authentication is performed using the biometric public key generated based on the face image captured at the time of registration and the biometric secret key generated based on the face image captured at the time of authentication. If the face image captured at the time of registration and the face image captured at the time of authentication are exactly the same, the authentication will succeed without problems. However, the face image captured at the time of registration and the face image captured at the time of authentication do not perfectly match because of fluctuations in position, posture, ambient light, and facial expression that change due to the different timing of the image capture. If the authentication does not succeed using the biometric secret key and the biometric public key even in the presence of such fluctuations, the reliability of the authentication will be reduced.

### SUMMARY OF THE INVENTION

The present invention has been made in order to solve the above problem. That is, an object of the present invention is to provide a face authentication terminal, a face authentication system, and a face authentication method that can reduce the possibility of a decrease in the reliability of face authentication.

In order to solve the above problem, the present disclosed face authentication terminal comprises a sensor including a camera. The present disclosed face authentication terminal configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key;
verify whether authentication is successful using the first biometric secret key and the biometric public key before registering the biometric public key in a key database present inside or outside the face authentication terminal; and
complete registration of the biometric public key in the key database when the authentication can be verified to be successful.

The present disclosed face authentication system comprises a face authentication terminal comprising a sensor including a camera; and an authentication device. The present disclose face authentication system is a system in which the face authentication terminal and the authentication device are configured to send and receive information to and from each other.

The face authentication terminal is configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key; and
transmit the biometric public key to the authentication device to request the authentication device to register the biometric public key.

The authentication device is configured to:
perform authentication using the first biometric secret key and the biometric public key received from the face authentication terminal to thereby verify whether the authentication is successful; and
complete registration of the biometric public key when it can be verified that the authentication is successful.

The present disclosed face authentication method uses a face authentication terminal comprising a sensor including a camera. The present disclosed face authentication method includes:
generating a first biometric secret key from a first face image, the first face image being one of two face images acquired by capturing a face of a person by the camera at each of a first timing when the person is detected by the sensor and a second timing when the person is detected by the sensor, the second timing being different from the first timing;
generating a second biometric secret key from a second face image, the second face image being the other of the two face images;
generating a biometric public key based on the second biometric secret key;
verifying whether authentication is successful using the first biometric secret key and the biometric public key before registering the biometric public key in a key database present inside or outside the face authentication terminal; and
completing registration of the biometric public key in the key database when the authentication can be verified to be successful.

The present invention can reduce the possibility of unreliable face authentication.

### BRIEF DESCRIPTION OF DRAWINGS

FIG. 1 shows an example system configuration of a face authentication system including a face authentication terminal according to a first embodiment of the present invention.

FIG. 2 shows a front view of the face authentication terminal to illustrate an example configuration.

FIG. 3A provides an overview of the operation of the face authentication system.

FIG. 3B provides an overview of the operation of the face authentication system.

FIG. 3C provides an overview of the operation of the face authentication system.

FIG. 3D provides an overview of the operation of the face authentication system.

FIG. 4 is a flowchart showing the processing flow executed by the CPU of the face authentication terminal for the first embodiment.

FIG. 5 is a flowchart showing the processing flow executed by the CPU of the face authentication terminal for the first embodiment.

FIG. 6 is a flowchart showing the processing flow executed by the CPU of the face authentication terminal for the first embodiment.

FIG. 7 illustrates an example configuration of a face authentication terminal for a second embodiment of the invention.

FIG. 8 is a flowchart showing the processing flow executed by the CPU of the face authentication terminal for the second embodiment.

FIG. 9 is a flowchart showing the processing flow executed by the CPU of the face authentication terminal for the second embodiment.

FIG. 10 is a flowchart showing the processing flow executed by the CPU of the face authentication terminal for a third embodiment.

FIG. 11 is a flowchart showing the processing flow executed by the CPU of the face authentication terminal for the third embodiment.

FIG. 12 is a flowchart showing the processing flow executed by the CPU of the face authentication terminal for the fifth embodiment.

FIG. 13A illustrates a variant of the face authentication system.

FIG. 13B illustrates a variant of the face authentication system.

FIG. 13C illustrates a variant of the face authentication system.

FIG. 13D illustrates a variant of the face authentication system.

### DETAILED DESCRIPTION OF THE EMBODIMENT

Each embodiment of the present invention will be described below with reference to the drawings. In all figures of the embodiments, identical or corresponding parts may be marked with the same symbol.

### First Embodiment

<Configuration>

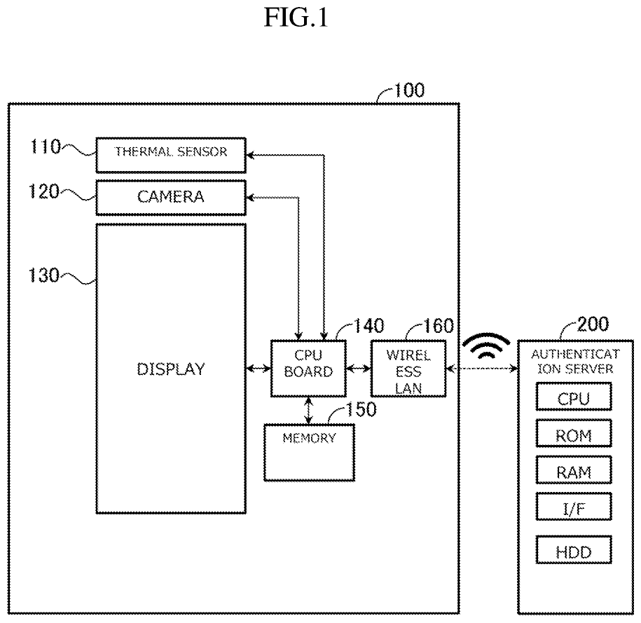

FIG. 1 is a schematic diagram showing an example configuration of a face authentication system according to the first embodiment of the present invention. As shown in FIG. 1, the face authentication system includes a face authentication terminal 100 and an authentication server 200. The face authentication terminal 100 and the authentication server 200 are connected to each other and can communicate with each other via a network. The authentication server 200 may also be referred to as the “authentication device” for convenience.

As shown in FIG. 1, the face authentication terminal 100 includes a thermal sensor 110, a camera 120, a display 130, a CPU board 140, a memory 150, and a wireless LAN 160. These are connected to each other via a bus, not shown in FIG. 1, so that they can send and receive information from each other.

The thermal sensor 110 is a temperature measurement sensor, for example, an infrared temperature sensor that detects the temperature of an object (person (user)) based on the amount of infrared energy emitted by the object being measured.

The camera 120 acquires user's face image by capturing the user's face present within the imaging range in front of the face authentication terminal 100.

The display 130 is a display device capable of displaying images. In this example, the display 130 is a touch panel display that functions as both the display device and an input device.

The CPU board 140 is a board mounted with a CPU and a ROM, etc. The CPU loads a program stored in the ROM into the memory 150. The CPU realizes various functions by executing the program loaded in the memory 150.

The memory 150 is, for example, a storage medium in which data can be read and written (e.g., a volatile RAM in which data can be read and written). The memory 150 is loaded with various programs to be executed by the CPU as described above and temporarily stores data used by the CPU in executing the various programs.

The wireless LAN 160 is a wireless LAN interface for connecting the face authentication terminal 100 to a network.

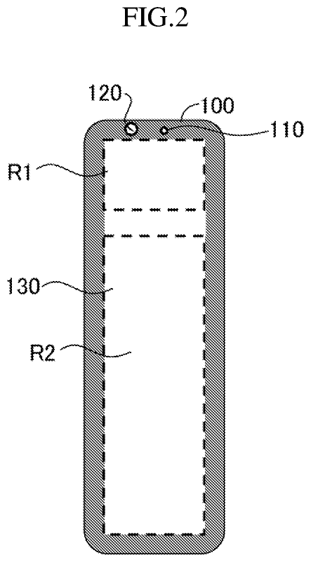

FIG. 2 shows a front view of the face authentication terminal 100 to illustrate an example of its configuration. As shown in FIG. 2, the thermal sensor 110 described above, the lens of the camera 120, and the display screen of the display 130 are located on the front of the face authentication terminal 100.

The thermal sensor 110 is located at the upper front edge of the face authentication terminal 100. The thermal sensor 110 detects the temperature of an object (person) by receiving infrared radiation emitted by an object to be measured (e.g., a user) that exists in front of the face authentication terminal 100.

The camera 120 is installed on the face authentication terminal 100 so that the lens of the camera 120 is positioned to the left of the thermal sensor 110 at the upper front edge of the face authentication terminal 100. The camera 120 acquires an image of a person's face (face image) by capturing the face of a person present within the imaging range of the camera 120 in front of the face authentication terminal 100.

The display 130 is capable of displaying images by dividing the screen into areas R1 and R2.

The authentication server 200 consists of a computer (a server, an information processing device) including a CPU, a ROM, a RAM, an interface I/F, and a non-volatile storage device (HDD) that can read and write data, etc. The CPU executes a program stored in the ROM to realize various functions. The CPU performs various functions by executing programs stored in the ROM. The authentication server 200 may comprise multiple information processing devices, and is not limited to physical information processing devices, but may also be a virtual information processing device.

The authentication server 200 stores (stores and maintains) a key database in the storage device (HDD) in which a public key and a PBI template (also referred to as a “biometric public key” or a “PBI public key”) and user information (e.g., user ID and password to identify the user) are stored in correspondence with each other.

<Overview>

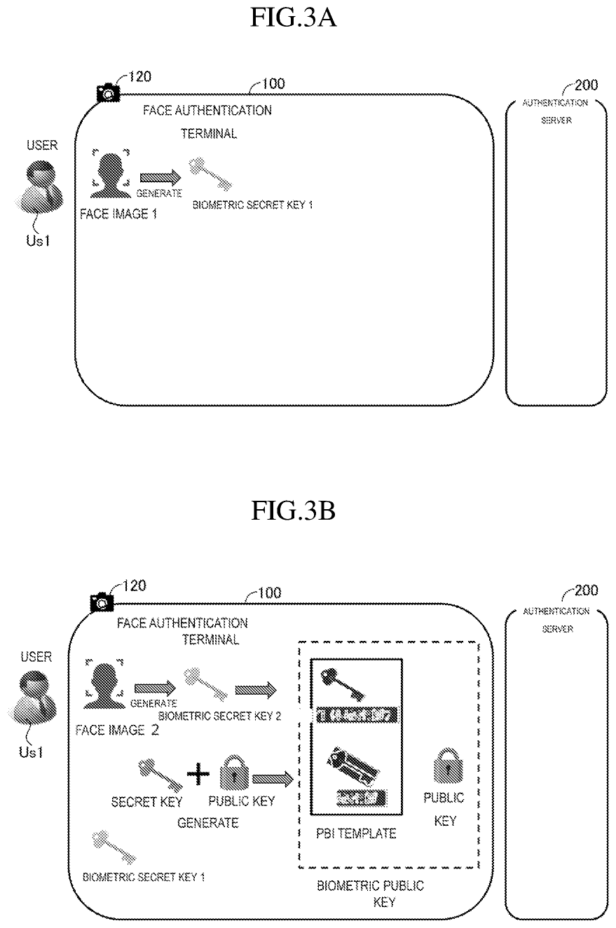

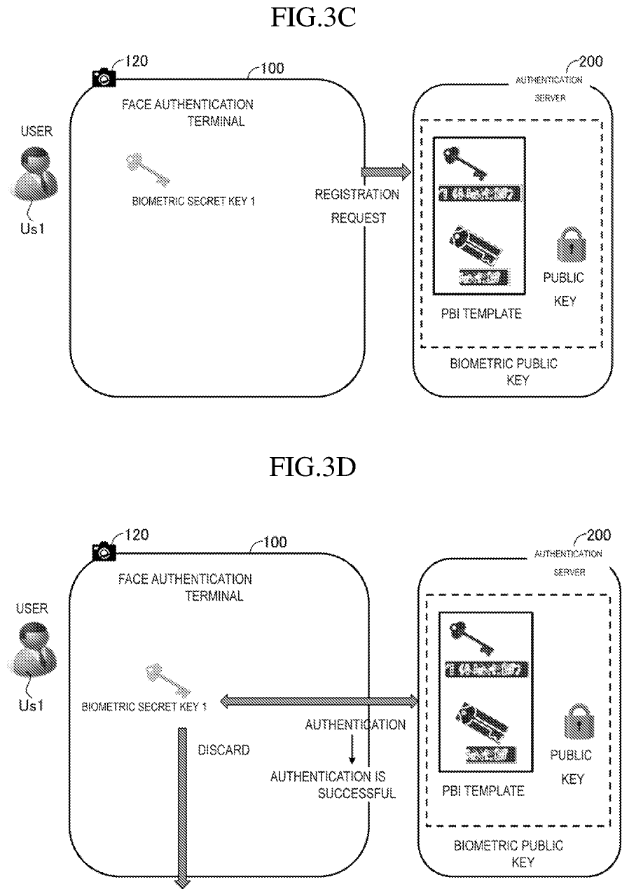

An overview of the operation of the face authentication system is described. As shown in FIG. 3A, the face authentication terminal 100 captures the face of a user Us1 by the camera 120 at the first timing when a person is detected by at least one of the camera 120 and the thermal sensor 110, to thereby acquire the face image 1 that is the captured image of the face of the user Us1 at the first timing. In this example, this first timing is the timing when the person is detected by the camera 120 and the thermal sensor 110. In this case, for example, when the face authentication terminal 100 can detect the face area of the user Us1 (detect the face) from the image captured by the camera 120, and can confirm that the image capture target with the detected face area is a person using the heat detected by the thermal sensor 110, the face authentication terminal 100 can detect the person.

The face authentication terminal 100 may, for example, use the timing when it detects the area of the face of the user Us1 from the captured image of the camera 120 as the first timing, and may use the timing when it detects the heat of the user Us1 by the thermal sensor 110 (i.e., the person is detected) by the thermal sensor 110 as the first timing used.

The face authentication terminal 100 generates (extracts) the biometric secret key 1 (facial feature information 1) from a face image 1 using a known algorithm. The technology disclosed in Japanese Unexamined Patent Application Publication No. 2013-123142 and Japanese Patent No. 6216567, etc., can be applied to this biometric secret key 1 generation method. The face authentication terminal 100 stores the biometric secret key 1.

Then, as shown in FIG. 3B, the face authentication terminal 100 acquires a face image 2, which is the captured image of the user Us1's face at the second timing, by capturing the face of the user Us1 with the camera 120 at the second timing after the first timing.

The face authentication terminal 100 extracts (generates) the biometric secret key 2 (facial feature information 2) from the face image 2, generates a secret key and a public key using existing cryptographic techniques, and generates a PBI template (sometimes also referred to as a “public template”) based on the biometric secret key 2 and the secret key. The techniques disclosed in Japanese Unexamined Patent Application Publication No. 2013-123142 and Japanese Unexamined Patent Application Publication No. 2019-161405, etc. can be applied to create the PBI template.

Next, as shown in FIG. 3C, the face authentication terminal 100 sends the biometric public key (PBI template and public key) to the authentication server 200, requests the authentication server 200 to register the biometric public key, and discards the biometric public key from the face authentication terminal 100. It should be noted that “destroying/discarding the biometric public key (information)” includes not leaving the information on the face authentication terminal 100 by deleting or overwriting the information, and not giving the information to other devices, etc.

Next, as shown in FIG. 3D, the authentication server 200 performs authentication using the biometric secret key 1 stored in the face authentication terminal 100 and the biometric public key for which enrollment is being requested from the authentication server 200. This authentication is performed, for example, by means of challenge-response authentication. That is, the authentication server 200 sends the PBI template and the challenge code to the face authentication terminal 100. The face authentication terminal 100 recovers (generates) the secret key from the biometric secret key 1 and the PBI template, signs (encrypts) the challenge code with the secret key, and sends it to the authentication server 200.

The authentication server 200 decrypts the encrypted challenge code with the public key contained in the biometric public key and compares whether the decrypted challenge code matches the previously transmitted challenge code. If they match, the authentication server 200 judges the authentication to be successful, and if they do not match, it judges the authentication to be unsuccessful.

If authentication is successful, the face authentication terminal 100 discards the biometric secret key 1, and the authentication server 200 completes the biometric public key registration. If authentication fails, the face authentication terminal 100 discards the biometric secret key 1, and the authentication server 200 does not register the biometric public key.

After the biometric public key registration is completed, when authenticating the user Us1, the face authentication terminal 100 generates a biometric secret key from the face image of the user Us1 for each authentication, and the generated biometric secret key and the biometric public key registered on the authentication server 200 are used for authentication in the face authentication system. It should be noted that the biometric secret key generated for each authentication is discarded from the face authentication terminal 100 when authentication is completed.

In this face authentication system, authentication using the biometric public key generated from the user's face image 2 taken at the second timing, which is different from the first timing, and the biometric secret key 1 generated from the user's face image 1 taken at the first timing, is successful, and authentication using the biometric public key in the enrollment/registration request is highly reliable. The registration of the biometric public key in the enrollment/registration request is completed after it is confirmed that the authentication using the biometric public key in the enrollment//registration request is reliable. This allows the face authentication system to improve the reliability of the face authentication of the user Us1 in the future.

The above is an overview of the operation of the face authentication system.

<Specific Operation>

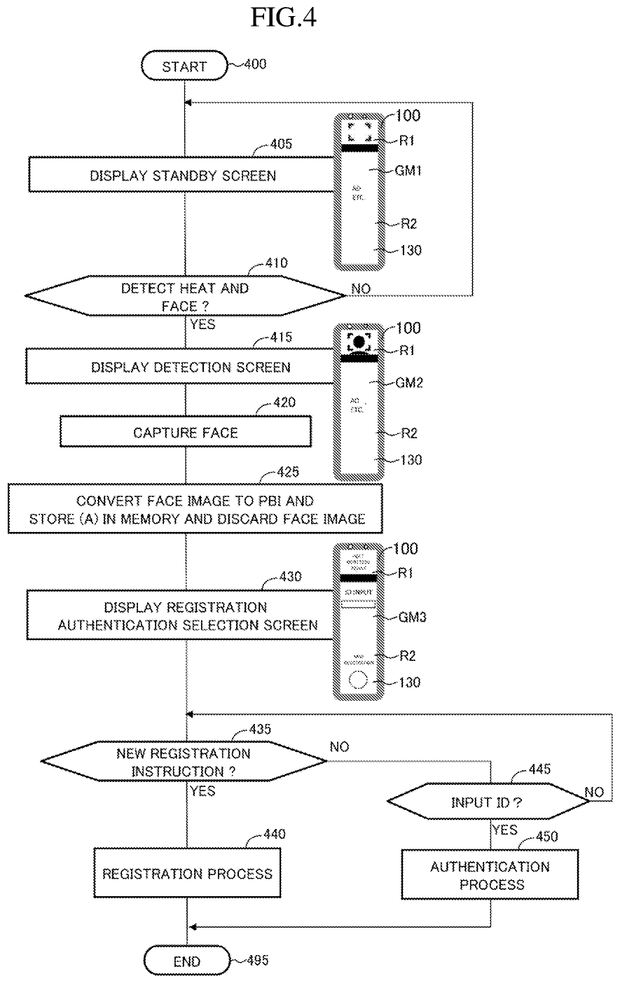

The specific operation of the face authentication system is described below. FIG. 4 is a flowchart showing the processing flow executed by the CPU of the face authentication terminal 100. The CPU of the face authentication terminal 100 starts processing from step 400 and proceeds to step 405 to display a standby screen GM1 on the display 130. The standby screen GM1 includes a frame for positioning the face for image capture in the area R1, and an arbitrary image (e.g., an image (including video) of content such as an advertisement) in the area R2.

The CPU then proceeds to step 410 to determine whether the thermal sensor 110 detects heat from the user (e.g., heat within a predetermined temperature range appropriate for determining that the user is human) and whether the camera 120 detects (recognizes) the user's face.

When both the user's heat and the user's face are not detected, the CPU makes a “NO” determination at step 410 and returns to step 405.

In contrast, when both the user's heat and the user's face are detected, the CPU makes a “YES” determination at step 410, executes steps 415 through 430 described below in sequence, and then proceeds to step 435.

Step 415: The CPU displays a detection screen GM2 on the display 130. The detection screen GM2 includes in the area R1 a frame for positioning the face for image capture and an image of the user's face reflected in the frame, and in the area R2 an arbitrary image (e.g., an image (including video) of content such as an advertisement).

Step 420: The CPU acquires the face image of the user by capturing the user's face using the camera 120.

Step 425: The CPU converts the face image to a PBI and stores (A) in the memory 150 and discards the face image. That is, the CPU generates (extracts) the biometric secret key (facial feature information) from the face image, stores the biometric secret key in the memory 150, and discards the face image. For convenience of explanation, the biometric secret key created in this step 425 is designated as (A).

Step 430: The CPU displays a registration authentication selection screen GM3 on the display 130.

The registration authentication selection screen GM3 includes information indicating the heat detection result (e.g., temperature) in the area R1, and includes an ID input column and a new registration button, which is a button composed of an image, in the area R2.

The CPU proceeds to step 435 to determine whether or not a new registration instruction has been given to the face authentication terminal 100 by the user touching the new registration button.

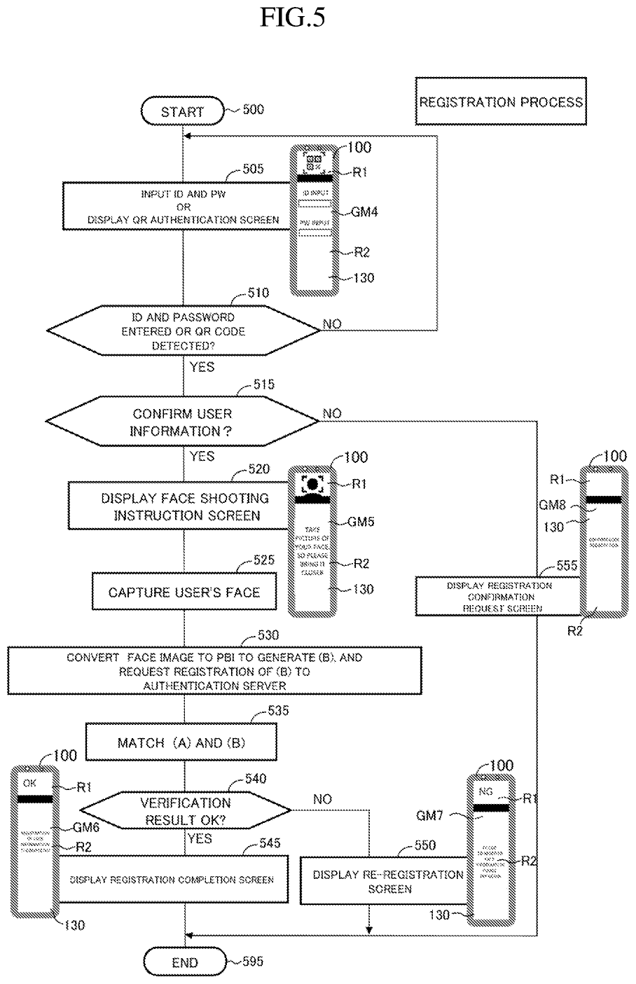

When the new registration instruction is received, the CPU makes a “YES” determination at step 435 and proceeds to step 440 to execute the registration process shown in FIG. 5 below, and then proceeds to step 495 to temporarily terminate this process flow.

When the new registration instruction is not received, the CPU makes a “NO” determination at step 435 and proceeds to step 445 to determine whether an ID (user ID) has been entered in the ID input field.

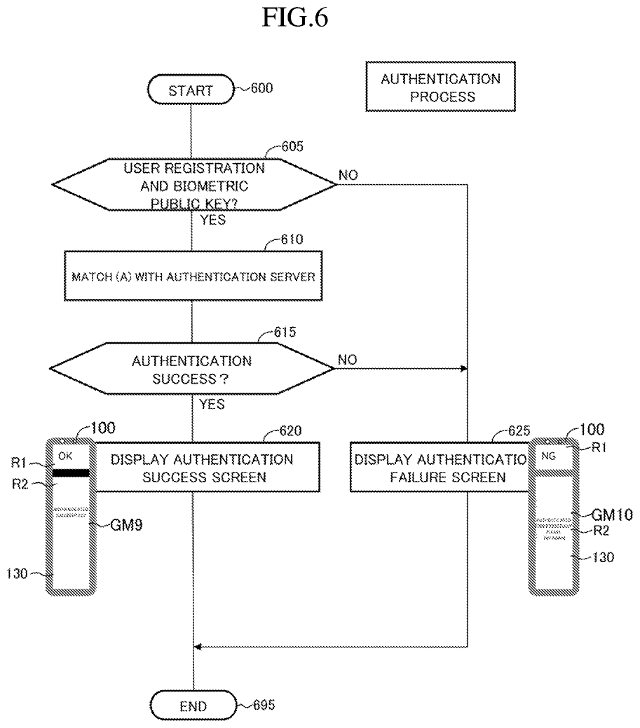

When an ID is entered in the ID input field, the CPU makes a “YES” determination at step 445 and proceeds to step 450 to execute the authentication process shown in FIG. 6 below, and then proceeds to step 495 to temporarily terminate this process flow.

When no ID is entered in the ID input field, the CPU makes a “NO” determination at step 445 and returns to step 435.

FIG. 5 is a flowchart showing the processing flow of the registration process described above executed by the CPU of the face authentication terminal 100. The CPU proceeds to step 440 in FIG. 4, starts processing from step 500 in FIG. 5 and proceeds to step 505 to display an input authentication screen GM4 on the display 130. The input authentication screen GM4 includes a frame for QR code (registered trademark) positioning in the area R1 and ID and PW input fields in the area R2.

The CPU then proceeds to step 510 to determine whether any of the “ID and password input” and “QR code detection” has been performed.

When neither “ID and password input” nor “QR code detection” is performed, the CPU makes a “NO” determination at step 510 and returns to step 505.

When either “input of ID and password” or “detection of QR code” is performed, the CPU makes a “YES” determination at step 510 and proceeds to step 515 to determine whether the user information (user ID and password) is registered in the key database of the authentication server 200.

When the user information is registered in the key database of the authentication server 200, the CPU makes a “YES” determination at step 515, performs steps 520 through 535 described below in sequence, and then proceeds to step 540.

Step 520: The CPU displays a face shooting instruction screen GM5 on the display 130. The face shooting instruction screen GM5 includes a frame for positioning and the face image of the user in the frame for positioning in the area R1, and includes instructions for the user to properly perform face shooting (face imaging) in the area R2.

Step 525: The CPU acquires the face image of the user by capturing the user's face using the camera 120.

Step 530: The CPU converts the face image into a PBI and requests the authentication server 200 to register the face image. That is, the CPU extracts (generates) the biometric secret key (facial feature information) from the face image acquired at Step 525, generates the secret key and the public key using existing encryption technology, and generates a PBI template from the biometric secret key (facial feature information) and the secret key. The CPU sends the generated the PBI template and the public key (that is, the biometric public key) to the authentication server 200 to request registration/enrollment of the biometric public key. The CPU then destroys/discards the biometric public key. For convenience of explanation, the biometric public key created/generated in this process is designated as (B).

Step 535: The CPU requests the authentication server 200 to check the biometric secret key ((A)) stored in the memory 150 at step 425 against the biometric public key ((B)) transmitted to the authentication server 200. When verification is requested, the authentication server 200 performs authentication using the biometric secret key ((A)) and the biometric public key ((B)) and sends the authentication result (either success or failure) to the face authentication terminal 100. When the verification result is OK (successful authentication), the authentication server 200 registers (stores) the biometric public key ((B)) in the key database in association with the user ID and password. This completes the registration of the biometric public key ((B)).

The CPU proceeds to step 540 to determine whether or not the received verification result is OK.

When the verification result is OK, the CPU makes a “Yes” determination at step 540 and proceeds to step 545 to display a registration completion screen GM6 on the display 130. The registration completion screen GM6 includes “OK” in the area R1 and a message including the fact that registration/enrollment is complete in the area R2. The CPU destroys/discards the biometric secret key ((A)) by deleting the biometric secret key ((A)) from the memory 150. The CPU then proceeds to step 595 to terminate this processing flow once and for all.

When the verification result is NG, the CPU makes a “NO” determination at step 540 and proceeds to step 550 to display a registration redoing screen GM7 on the display 130. The registration redoing screen GM7 includes “NG” in the area R1 and a message indicating that the registration has failed and requesting re-registration from the beginning in the area R2. The CPU destroys/discards the biometric secret key ((A)) by deleting the biometric secret key ((A)) from the memory 150. In the case of redoing the registration/enrollment, the user starts over from the heat detection and face detection (the process is performed from step 405). The CPU then proceeds to step 595 to terminate this processing flow once and for all.

When the user information is not registered in the key database at step 515 above, the CPU makes a “NO” determination at step 515 and proceeds to step 555 to display a registration confirmation request screen GM8 on the display 130. The registration confirmation request screen GM8 includes a message in the area R2 requesting the user to confirm the registration. The CPU then proceeds to step 595 to tentatively terminate this processing flow.

FIG. 6 is a flowchart showing the processing flow of the authentication process described above executed by the CPU of the face authentication terminal 100. When the CPU proceeds to step 450 in FIG. 4, the CPU starts processing from step 600 of FIG. 6 to determines whether or not the user information is registered in the key database of the authentication server 200 and the biometric public key corresponding to the user information (hereinafter referred to as the “registered biometric public key”) is present in the key database of the authentication server 200.

When the user information is registered in the key database and the registered biometric public key corresponding to the user information is present in the key database, the CPU makes a “YES” determination at step 605 and proceeds to step 610 to request the authentication server 200 to match the biometric secret key ((A)) stored in the memory 150 at step 425 with the registered biometric public key (verification of the biometric secret key ((A)) with registered biometric public key).

When verification is requested, the authentication server 200 performs authentication using the biometric secret key ((A)) and the registered biometric public key, and sends the authentication result (either success or failure) to the face authentication terminal 100.

The CPU proceeds to step 615 to determine, based on the authentication result, whether or not the authentication was successful. That is, when the authentication result is a success, the CPU determines that the authentication was successful, and when the authentication result is a failure, the CPU determines that the authentication failed.

When the authentication is successful, the CPU makes a “YES” determination at step 615 and proceeds to step 620 to display an authentication success screen GM9 on the display 130. The authentication success screen GM9 includes “OK” in the area R1 and a message including the fact that the authentication was successful in the area R2. The CPU destroys/discards the biometric secret key ((A)) by deleting the biometric secret key ((A)) from the memory 150. The CPU then proceeds to step 695 to terminate this processing flow once and for all.

When the authentication fails, the CPU makes a “NO” determination at step 615 and proceeds to step 625 to display an authentication failure screen GM10 on the display 130. The authentication failure screen GM10 includes “NG” in the area R1 and a message including the fact that authentication failed in the area R2. The CPU destroys/discards the biometric secret key ((A)) by deleting the biometric secret key ((A)) from the memory 150. The CPU then proceeds to step 695 to terminate this processing flow once and for all.

When at least one of the “user information” and the “biological public key corresponding to the user information” is not registered in the key database in the processing of step 605 described above, the CPU makes a “NO” determination at step 605 and proceeds to step 625 to perform the processing of step 625 described above, and then, proceeds to step 695 to terminate this processing flow once and for all.

<Effect>

As explained above, the face authentication terminal 100 according to the first embodiment of the present invention and the face authentication system including the face authentication terminal 100 can reduce the possibility of face authentication reliability degradation.

### Second Embodiment

The face authentication terminal 100 of the second embodiment of the present invention will be described. The face authentication terminal 100 according to the second embodiment differs from the face authentication system of the first embodiment only in that the authentication server 200 is omitted from the face authentication system of the first embodiment, and the functions of the authentication server 200 are provided by the face authentication terminal 100.

The following explanation focuses on these differences.

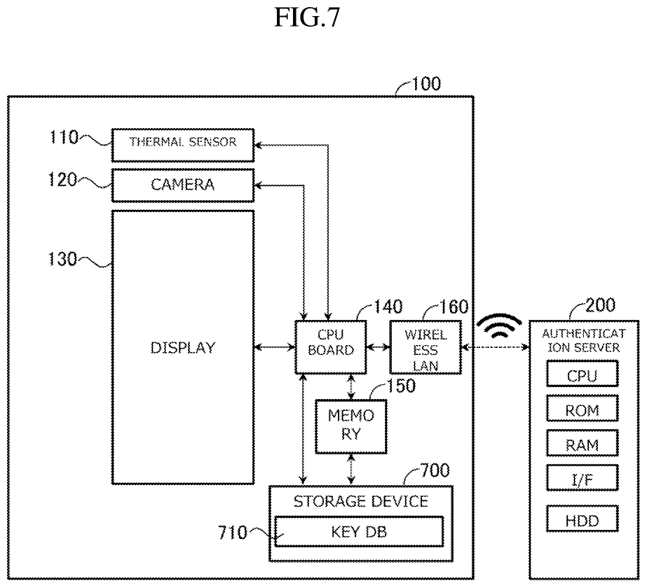

FIG. 7 illustrates an example configuration of the face authentication terminal 100 of the second embodiment. It should be noted that the authentication server 200 may be omitted in FIG. 7. As shown in FIG. 7, the face authentication terminal 100 is equipped with a storage device 700. The storage device 700 is a nonvolatile storage medium capable of reading and writing data. The storage device 700 includes (holds (stores)) a key database 710. This key database 710 is the same as the key database stored in the storage device of the authentication server 200 in the first embodiment. That is, the key database 710 contains a public key and a PBI template (a biometric public key) associated with user information (e.g., user ID and password to identify the user).

<Specific Operation>

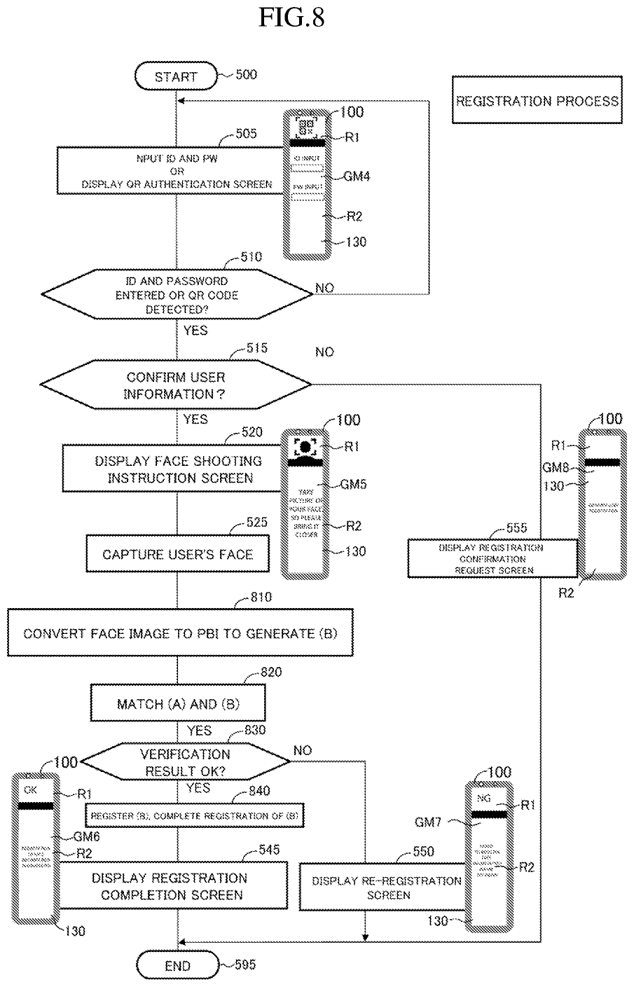

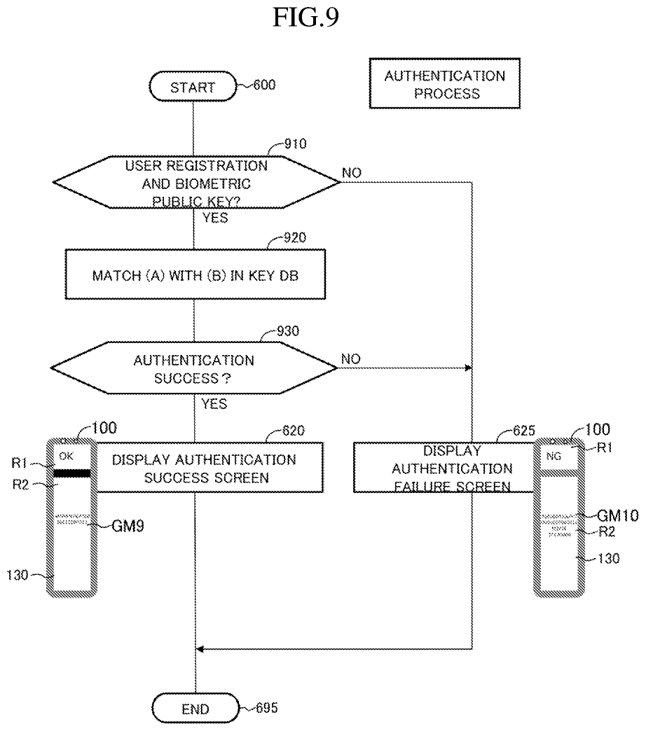

The specific operation of the face authentication terminal 100 according to the second embodiment is described below. The CPU of the face authentication terminal 100 executes the processing flow shown in the flowchart in FIG. 4 described above, the processing flow shown in the flowchart in FIG. 8, and the processing flow shown in the flowchart in FIG. 9. It should be noted that the processing flow in FIG. 4 has already been described, so the description is omitted.

FIG. 8 is a flowchart showing the processing flow executed by the CPU of the face authentication terminal 100. The processing flow of FIG. 8 differs from the processing flow of FIG. 5 only in that steps 530 through 540 are replaced by steps 810 through 840. Therefore, the following explanation focuses on the different processing and omits the other explanations.

The CPU proceeds to step 810 to PBI-ize the face image. That is, the CPU extracts (generates) the biometric secret key (facial feature information) from the face image acquired at step 525, generates a secret key and a public key using existing encryption technology, and generates a PBI template from the biometric secret key (the facial feature information) and the secret key. For convenience of explanation, the public key and the PBI template (the biometric public key) created by this process are designated as (B).

The CPU then proceeds to step 820 to check the biometric secret key ((A)) stored in the memory 150 in step 425 of FIG. 4 against the biometric public key ((B)) (verify the biometric secret key ((A)) and the biometric public key ((B))). That is, the CPU performs authentication using the biometric secret key ((A)) and the biometric public key ((B)) to determine whether or not authentication is possible.

The CPU then proceeds to step 830 to determine whether or not the verification result is OK (successful authentication result). When the verification result is OK, the CPU makes a “YES” determination at step 830 and proceeds to step 840 to register (store) the biometric public key ((B)) in the key database 710 in association with the user ID and password and discard the biometric secret key ((A)). This completes the registration of the biometric public key ((B)). The CPU then proceeds to step 545.

In contrast, when the verification result is NG, the CPU makes a “NO” determination at step 830 and proceeds to step 550. It should be noted that in this case, the CPU also discards the biometric secret key ((A)).

FIG. 9 is a flowchart showing the processing flow executed by the CPU of the face authentication terminal 100. The flowchart in FIG. 9 differs from the processing flow of FIG. 6 only in that steps 605 through 615 of FIG. 6 are replaced by steps 910 through 930. Therefore, the following explanation focuses on the different processing and omits the other explanations.

The CPU proceeds to step 910 to check whether the user information is registered in the key database 710 and whether the biometric public key (the registered biometric public key) corresponding to the user information is present in the key database 710.

When the user information is registered in the key database 710 and the registered biometric public key corresponding to the user information is present in the key database 710, the CPU makes a “Yes” determination at step 910 and proceeds to step 920 to check the biometric secret key ((A)) stored in the memory 150 at step 425 of FIG. 4 against the registered biometric public key (verify the biometric secret key ((A)) and the registered biometric public key).

At step 930, the CPU determines whether or not the authentication is successful. When the authentication is successful, the CPU makes a “YES” determination at step 930 and proceeds to step 620. When the authentication failed (is unsuccessful), the CPU makes a “NO” determination at step 930 and proceeds to step 625.

It should be noted that when at least one of the “user information” and the “biometric public key corresponding to the user information” is not registered in the key database 710 in the processing of step 910 described above, the CPU makes a “NO” determination at step 910 and proceeds to step 625.

<Effect>

As explained above, the face authentication terminal 100 according to the second embodiment of the present invention, like the first embodiment, can reduce the possibility of reduced reliability of face authentication.

### Third Embodiment

This section describes the face authentication system including the face authentication terminal 100 according to the third embodiment of the present invention. This face authentication system differs from the face authentication system according to the first embodiment only in the following points.

In the first embodiment, authentication in the registration and authentication process are performed by the authentication server 200, but in the third embodiment, authentication is performed by the face authentication terminal 100.

The following explanation focuses on these differences.

<Specific Operation>

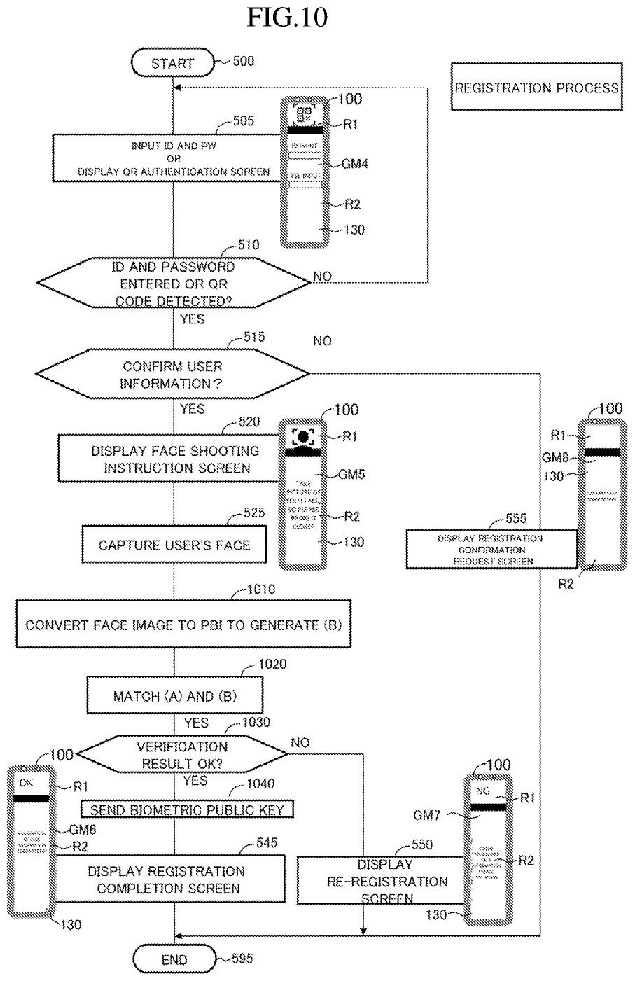

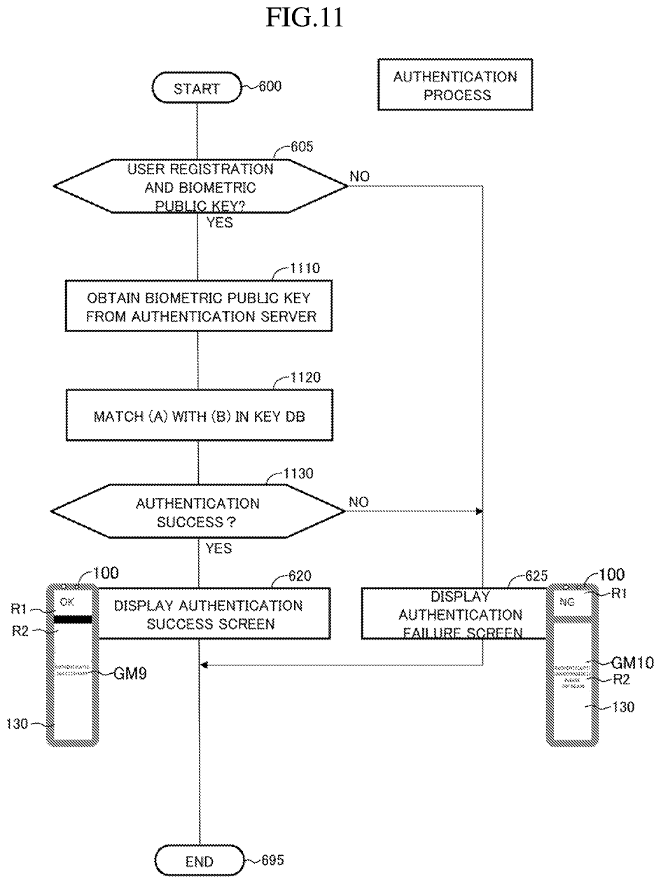

The specific operation of the face authentication terminal 100 of the third embodiment is described below. The CPU of the face authentication terminal 100 executes the processing flow shown in the flowchart in FIG. 4 described above, the processing flow shown in the flowchart in FIG. 10, and the processing flow shown in the flowchart in FIG. 11. It should be noted that the processing flow in FIG. 4 has already been described above, so the description is omitted.

FIG. 10 is a flowchart showing the processing flow executed by the CPU of the face authentication terminal 100. The processing flow shown in FIG. 10 differs from the processing flow of FIG. 5 only in that steps 530 through 540 are replaced by steps 1010 through 1040. Therefore, the following explanation focuses on the different processing and omits the other explanations.

The CPU proceeds to step 1010 to PBI-ize the face image. That is, the CPU extracts (generates) a biometric secret key (facial feature information) from the face image acquired at step 525, generates a secret key and a public key using existing encryption technology, and generates a PBI template from the biometric secret key (the facial feature information) and the secret key. That is, the CPU generates the PBI template and the public key (the biometric public key). For convenience of explanation, the biometric public key created by this process is designated as (B).

The CPU then proceeds to step 1020 to check the biometric secret key ((A)) stored in the memory 150 in step 425 of FIG. 4 against the biometric public key ((B)) (verify the biometric secret key ((A)) and the biometric public key ((B))). That is, the CPU performs authentication using the biometric secret key ((A)) and the biometric public key ((B)).

The CPU proceeds to step 1030 to determine whether the verification result is OK (successful authentication result).

When the verification result is OK, the CPU makes a “Yes” determination at step 1030 and proceeds to step 1040 to send the biometric public key ((B)) associated with the user ID and password to the authentication server 200 and discard the biometric secret key (A). The authentication server 200 registers (stores) the biometric public key ((B)) in the key database in association with the user ID and password. This completes the registration of the biometric public key ((B)). The CPU then proceeds to step 545.

When the verification result is NG, the CPU makes “NO” determination at step 1030 and proceeds to step 550. In this case, the CPU discards the biometric secret key ((A)) and the biometric public key ((B)).

FIG. 11 is a flowchart showing the processing flow executed by the CPU of the face authentication terminal 100. The processing flow in FIG. 11 differs from the processing flow of FIG. 6 only in that steps 610 through 615 of FIG. 6 are replaced by steps 1110 through 1130. Therefore, the following explanation focuses on the different processing, and other explanations are omitted.

The CPU proceeds to step 1110 to obtain from the authentication server 200 the registered biometric public key corresponding to the user information (the user ID entered in step 445 of FIG. 4).

The CPU proceeds to step 1120 to check the registered biometric public key against the biometric secret key ((A)) stored in the memory 150 in step 425 of FIG. 4 (verify the registered biometric public key and the biometric secret key ((A))).

The CPU determines whether or not the authentication is successful at step 1130. When the authentication is successful, the CPU makes a “YES” determination at step 1130 and proceeds to step 620. When the authentication fails, the CPU makes a “NO” determination at step 1130 and proceeds to step 625.

<Effect>

As explained above, the face authentication terminal 100 according to the third embodiment of the present invention, like the first embodiment, can reduce the possibility of face authentication reliability degradation.

### Fourth Embodiment

This section describes the face authentication system including the face authentication terminal 100 according to the fourth embodiment of the present invention. This face authentication system differs from the face authentication system of the first embodiment only in the following points.

In the first embodiment, authentication in the authentication process is performed by the authentication server 200, but in the fourth embodiment, authentication is performed by the face authentication terminal 100.

The following explanation focuses on these differences.

<Specific Operation>

The specific operation of the face authentication terminal 100 of the fourth embodiment will now be described. The CPU of the face authentication terminal 100 executes the processing flow shown in the flowchart in FIG. 4 described above, the processing flow shown in the flowchart in FIG. 5, and the processing flow shown in the flowchart in FIG. 11. It should be noted that these processing flows have already been described, so the explanation is omitted.

<Effect>

As explained above, the face authentication terminal 100 according to the fourth embodiment of the invention, like the first embodiment, can reduce the possibility of reduced reliability of face authentication.

### Fifth Embodiment

This section describes the face authentication system including the face authentication terminal 100 of the fifth embodiment of the present invention. This face authentication system differs from the face authentication system according to the first embodiment only in the following points.

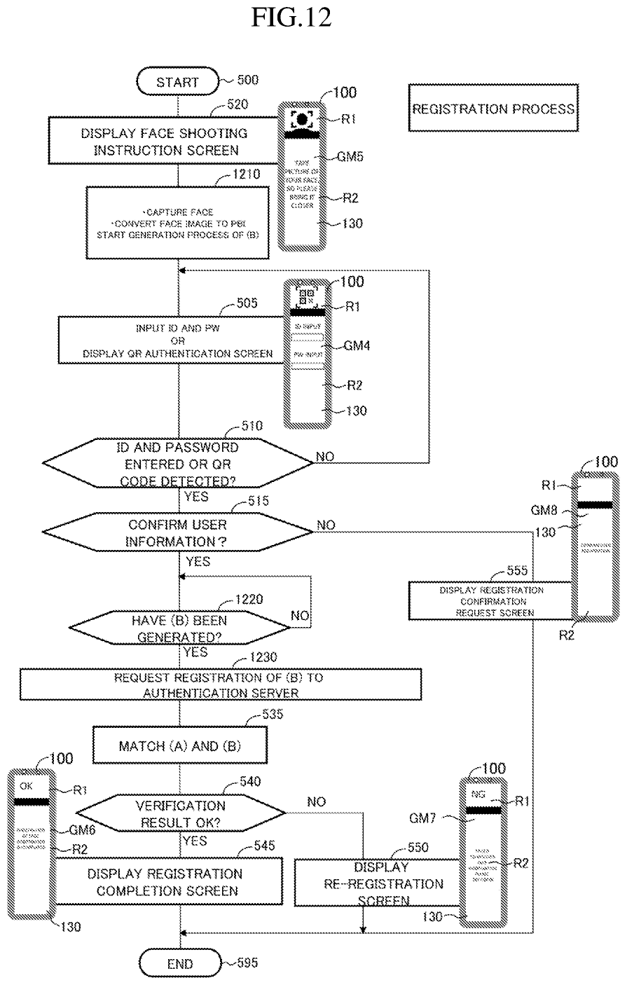

This face authentication system executes the flowchart shown in FIG. 12 instead of the flowchart shown in FIG. 5.

The following explanation focuses on these differences.

The processing flow in FIG. 12 differs from that of FIG. 5 only in that step 520 is moved immediately after step 500, step 1210 is added between steps 520 and 505, and steps 525 and 530 are replaced by steps 1220 and 1230. Therefore, the following explanation focuses on the different processing and omits the other explanations.

The CPU of the face authentication terminal 100 starts processing from step 500 of FIG. 12 and proceeds to step 520 to display the face shooting instruction screen GM5 on the display 130. The CPU then proceeds to step 1210 to acquire the face image of the user by capturing the user's face using the camera 120. Furthermore, the CPU initiates the process of converting the face image into a PBI. That is, the CPU extracts (generates) a biometric secret key (facial feature information) from the acquired face image, generates a secret key and a public key (biometric public key) using existing encryption technology, and starts the process of generating a PBI template from the biometric secret key (facial feature information) and the secret key. For convenience of explanation, the biometric public key is designated as (B). The CPU then proceeds to step 505.

When the CPU makes a “Yes” determination at step 510 and step 515, respectively, after executing the process of step 505, it proceeds to step 1220 to determine whether the biometric public key (B) is generated at this time.

When the biometric public key ((B)) has not been generated at this time, the CPU makes a “NO” determination at step 1220 and returns to step 1220 again. When the biometric public key ((B)) has been generated at this time, the CPU makes a “YES” determination at step 1220 and proceeds to step 1230. The CPU proceeds to step 1230, requests the authentication server 200 to register the biometric public key ((B)) and proceeds to step 535.

<Effect>

As explained above, the face authentication terminal 100 according to the fifth embodiment of the present invention, as in the first embodiment, can reduce the possibility of a decrease in the reliability of face authentication. Furthermore, the face authentication terminal 100 according to the fifth embodiment makes the user unaware of the time required for PBI processing by having the user input user information during the time-consuming process of converting face images to PBI. This reduces the possibility that the user will be bothered by the time required to process the face image into the PBI. It should be noted that the features of the fifth embodiment may be applied to the second through fourth embodiments.

### Modified Example

The present invention is not limited to the above embodiments, and various variations may be employed within the scope of the present invention. Furthermore, the above embodiments can be combined with each other as long as they do not depart from the scope of the present invention.

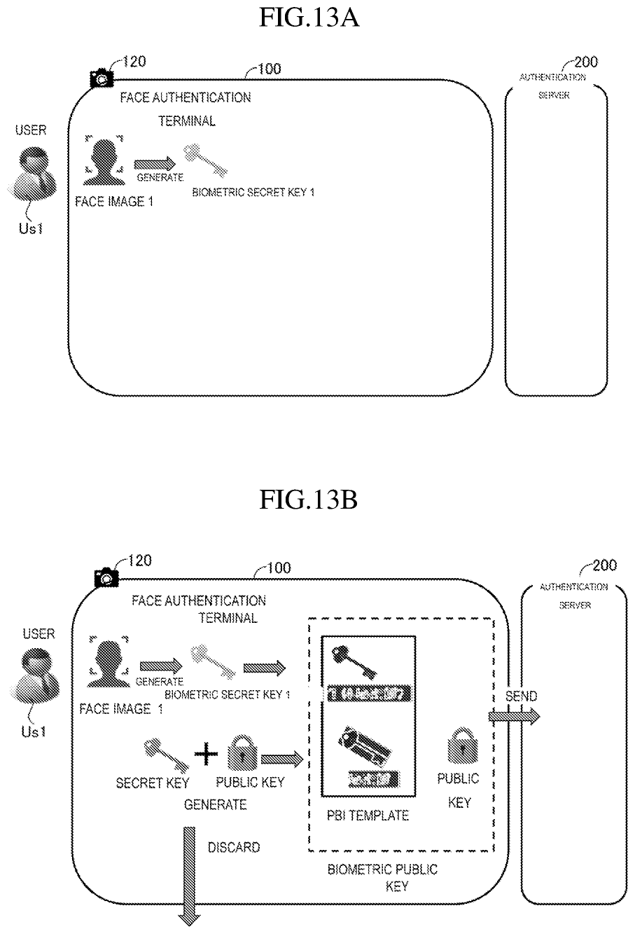

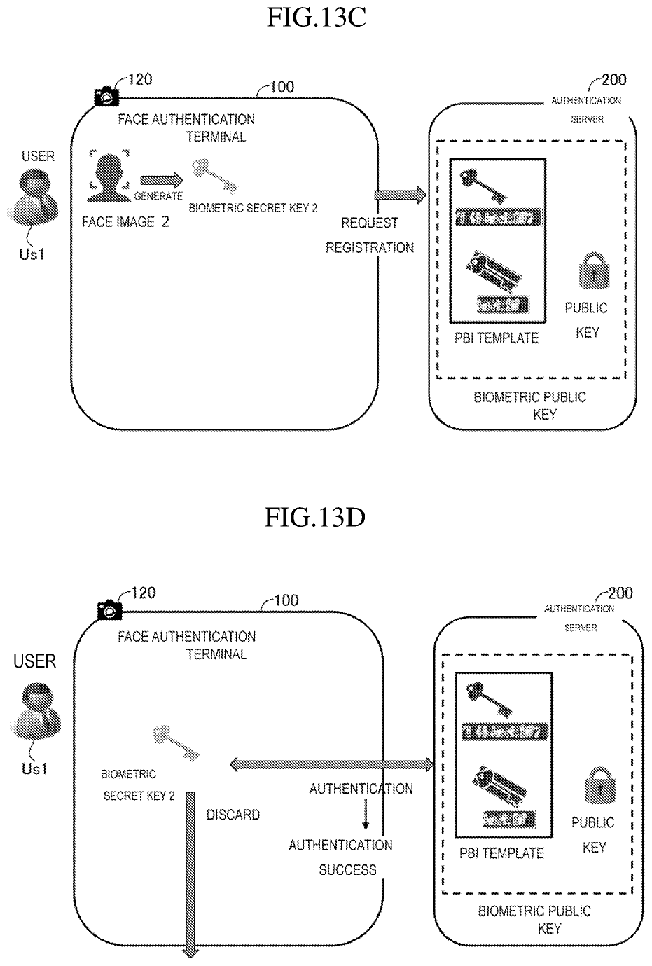

For example, in the first embodiment above, the face authentication system may operate as described below (the features of this variation described below may be applied to the second through fourth embodiments). That is, as shown in FIG. 13A, the face authentication terminal 100 captures the face of the user Us1 by the camera 120 at the first timing when the user Us1 is detected by at least one of the camera 120 and the thermal sensor 110 to acquire a face. Thereby, the face authentication terminal 100 acquires the face image 1 that is the captured image of the face captured at the first timing. The face authentication terminal 100 generates (extracts) the biometric secret key 1 (facial feature information 1) from the face image 1.

As shown in FIG. 13B, the face authentication terminal 100 generates a secret key and a public key using existing cryptographic techniques, and generates a PBI template based on the biometric secret key 1 and the secret key. The face authentication terminal 100 sends the biometric public key (PBI template and public key) to the authentication server 200. The face authentication terminal 100 then destroys/discards the biometric secret key 1 and the biometric public key (PBI template and public key).

As shown in FIG. 13C, the face authentication terminal 100 acquires the face image 2, which is the captured image of the face of the user Us1 at the second timing, by capturing the face of the user Us1 with the camera 120 at the second timing after the first timing. The face authentication terminal 100 extracts (generates) the biometric secret key 2 (facial feature information 2) from the face image 2 and requests the registration of the biometric public key sent to the authentication server 200 in the previous process.

As shown in FIG. 13D, the authentication server 200 performs authentication using the biometric secret key 2 and the biometric public key that is being requested for enrollment/registration in the authentication server 200.

When authentication is successful, the face authentication terminal 100 discards the biometric secret key 2, and the authentication server 200 completes the biometric public key registration. It should be noted that when authentication fails, the face authentication terminal 100 discards the biometric secret key 2, and the authentication server 200 does not register the biometric public key.

For example, in each of the above embodiments, the example configuration of the face authentication terminal 100 is an example, and a human sensor such as an ultrasonic sensor, sound sensor, touch sensor, etc. may be used instead of the thermal sensor 110. Furthermore, in each of the above embodiments, the thermal sensor 110 may be omitted.

For example, in each of the above embodiments, the face authentication terminal 100 automatically captures the user's face with the camera 120 when detecting a person, but it may also display an instruction button indicating that the face image for verification to be captured, and acquire the face image for verification by capturing the user's face at a time point/timing when the instruction button is operated.

For example, in each of the above embodiments, a biometric public key may be registered when authentication is performed using each of the multiple biometric secret keys generated based on multiple face images captured at two or more timings and the biometric public key, and when all authentication results are successful.

The present invention can also be configured as follows.

[1]

A face authentication terminal comprising a sensor including a camera, the face authentication terminal configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key;
verify whether authentication is successful using the first biometric secret key and the biometric public key before registering the biometric public key in a key database present inside or outside the face authentication terminal; and
complete registration of the biometric public key in the key database when the authentication can be verified to be successful.

[2]

The face authentication terminal according to [1],
wherein
the key database is present outside the face authentication terminal;
the face authentication terminal is configured to:
   be capable of sending and receiving information to and from each other with the authentication device including the key database;
   register the biometric public key in the key database included in the authentication device;
   send the biometric public key to the authentication device to request the authentication device to register the biometric public key in the key database; and
verify whether the authentication is successful by having the authentication device perform the authentication using the first biometric secret key and the biometric public key received from the face authentication terminal.

[3]

The face authentication terminal according to [1],
wherein
the key database is inside the face authentication terminal; and
the face authentication terminal further has a storage device in which the key database is stored.

[4]

The face authentication terminal according to [1],
wherein
the sensor includes other sensors other than the camera; and
the face authentication terminal is configured to use, as the first timing, a timing when the person is detected by at least one of the other sensors and the camera.

[5]

The face authentication terminal according to [1],
wherein
the face authentication terminal is configured to:
acquire the first face image by capturing the face of the person at the first timing; and
acquire the second face image by capturing the face of the person at the second timing after the first timing.

[6]

The face authentication terminal according to [5],
wherein
the face authentication terminal has a display device capable of displaying images, and
the face authentication terminal is configured to:
   display a face capture instruction screen including information indicating an instruction to capture a face on the display device; and
   capture the face of the person at the second timing.

According to the face authentication terminal of [6], the first face image captured by the camera without the user being aware that it is for authentication is acquired at the first timing detected by the person detection sensor, and the second face image captured by the camera with the user aware that it is for authentication is acquired.

This allows the face authentication terminal of [6] to improve the possibility of obtaining two face images for verification that have larger fluctuations, such as different facial expressions. Based on the two face images for verification with larger fluctuations, the success of authentication is verified and the biometric public key is registered, thereby improving the reliability of subsequent authentication.

[7]

The face authentication terminal according to [6],
wherein
the face authentication terminal is configured to:
start, after capturing the face of the person at the second timing, a process of generating the second biometric secret key from the second face image; and
display a screen for having the person enter user information on the display device during a period between start of the process and completion of generation of the second biometric secret key.

[8]

The face authentication terminal according to [2],
wherein
the face authentication terminal is configured to:
   acquire the first face image by capturing the face of the person at the first timing;
   acquire the second face image by capturing the face of the person at the second timing, the second timing being later than the first timing;
   store the first biometric secret key generated from the first face image captured at the first timing;
   discard, after transmitting the biometric public key to the authentication device, the second biometric secret key and the biometric public key; and
   discard the first biometric secret key after the authentication device performing the authentication.

According to the face recognition terminal of [8], the first biometric secret key, the second biometric secret key, and the biometric public key can be destroyed/discarded to prevent the information necessary for the authentication from being illegally obtained by others.

[9]

The face authentication terminal according to [1],
wherein
the face authentication terminal includes a display device capable of displaying images; and
the face authentication terminal displays a screen on the display device according to verification results.

[10]

The face authentication terminal according to [4],
wherein
one of the other sensors is a thermal sensor that detects heat of the person.

[11]

The face authentication terminal according to [1],
wherein
the face authentication terminal is configured to:
   when performing face authentication after completing the registration of the biometric public key,
generate the biometric secret key for authentication from the face image for authentication obtained by capturing the face of the person with the camera at a timing when the person is detected by the sensor;
obtain the registered biometric public key from the key database;
perform the authentication using the biometric secret key and the registered biometric public key; and
discard, after performing the authentication, the biometric secret key for authentication.

[12]

The face authentication terminal according to [2],
wherein
the face authentication terminal is configured to:
   when performing face authentication after completing the registration of the biometric public key,
generate the biometric secret key for authentication from the face image for authentication obtained by capturing the face of the person with the camera at a timing when the person is detected by the sensor;
cause the authentication device to perform authentication using the biometric secret key and the registered biometric public key; and
discard, after the authentication device performing the authentication, the biometric secret key for authentication.

According to the face authentication terminals of [11] and [12], by destroying/discarding the biometric secret key for authentication, it is possible to prevent the information necessary for authentication from being illegally obtained by others.

[13]

The face authentication terminal according to [1],
wherein
the face authentication terminal is configured to capture the face of the person at the first timing and the second timing to thereby acquire the first face image and the second face image, facial expressions of the person in the first image and the second image being different from each other.

[14]

The face authentication terminal according to claim [1],

wherein
the face authentication terminal is configured to:
acquire the second face image by capturing the face of the person at the first timing; and
acquire the first face image by capturing the face of the person at the second timing after the first timing.

[15]

A face authentication system comprising a face authentication terminal comprising a sensor including a camera; and an authentication device, the face authentication system being a system in which the face authentication terminal and the authentication device are configured to send and receive information to and from each other,
wherein,
the face authentication terminal is configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key; and
transmit the biometric public key to the authentication device to request the authentication device to register the biometric public key; and
the authentication device is configured to:
perform authentication using the first biometric secret key and the biometric public key received from the face authentication terminal to thereby verify whether the authentication is successful; and
complete registration of the biometric public key when it can be verified that the authentication is successful.

[16]

A face authentication method using a face authentication terminal comprising a sensor including a camera, the face authentication method including:
generating a first biometric secret key from a first face image, the first face image being one of two face images acquired by capturing a face of a person by the camera at each of a first timing when the person is detected by the sensor and a second timing when the person is detected by the sensor, the second timing being different from the first timing;
generating a second biometric secret key from a second face image, the second face image being the other of the two face images;
generating a biometric public key based on the second biometric secret key;
verifying whether authentication is successful using the first biometric secret key and the biometric public key before registering the biometric public key in a key database present inside or outside the face authentication terminal; and
completing registration of the biometric public key in the key database when the authentication can be verified to be successful.

1. A face authentication terminal comprising a sensor including a camera, the face authentication terminal configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key;
verify whether authentication is successful using the first biometric secret key and the biometric public key before registering the biometric public key in a key database present inside or outside the face authentication terminal; and
complete registration of the biometric public key in the key database when the authentication can be verified to be successful.

2. The face authentication terminal according to claim 1,
wherein
the key database is present outside the face authentication terminal;
the face authentication terminal is configured to:
be capable of sending and receiving information to and from each other with the authentication device including the key database;
register the biometric public key in the key database included in the authentication device;
send the biometric public key to the authentication device to request the authentication device to register the biometric public key in the key database; and
verify whether the authentication is successful by having the authentication device perform the authentication using the first biometric secret key and the biometric public key received from the face authentication terminal.

3. The face authentication terminal according to claim 1,
wherein
the key database is inside the face authentication terminal; and
the face authentication terminal further has a storage device in which the key database is stored.

4. The face authentication terminal according to claim 1,
wherein
the sensor includes other sensors other than the camera; and
the face authentication terminal is configured to use, as the first timing, a timing when the person is detected by at least one of the other sensors and the camera.

5. The face authentication terminal according to claim 1,
wherein
the face authentication terminal is configured to:
acquire the first face image by capturing the face of the person at the first timing; and
acquire the second face image by capturing the face of the person at the second timing after the first timing.

6. The face authentication terminal according to claim 5,
wherein
the face authentication terminal has a display device capable of displaying images, and
the face authentication terminal is configured to:
display a face capture instruction screen including information indicating an instruction to capture a face on the display device; and
capture the face of the person at the second timing.

7. The face authentication terminal according to claim 6,
wherein
the face authentication terminal is configured to:
start, after capturing the face of the person at the second timing, a process of generating the second biometric secret key from the second face image; and
display a screen for having the person enter user information on the display device during a period between start of the process and completion of generation of the second biometric secret key.

8. The face authentication terminal according to claim 2,
wherein
the face authentication terminal is configured to:
acquire the first face image by capturing the face of the person at the first timing;
acquire the second face image by capturing the face of the person at the second timing, the second timing being later than the first timing;
store the first biometric secret key generated from the first face image captured at the first timing;
discard, after transmitting the biometric public key to the authentication device, the second biometric secret key and the biometric public key; and
discard the first biometric secret key after the authentication device performing the authentication.

9. The face authentication terminal according to claim 1,
wherein
the face authentication terminal includes a display device capable of displaying images; and
the face authentication terminal displays a screen on the display device according to verification results.

10. The face authentication terminal according to claim 4,
wherein
one of the other sensors is a thermal sensor that detects heat of the person.

11. The face authentication terminal according to claim 1,
wherein
the face authentication terminal is configured to:
when performing face authentication after completing the registration of the biometric public key,
generate the biometric secret key for authentication from the face image for authentication obtained by capturing the face of the person with the camera at a timing when the person is detected by the sensor;
obtain the registered biometric public key from the key database;
perform the authentication using the biometric secret key and the registered biometric public key; and
discard, after performing the authentication, the biometric secret key for authentication.

12. The face authentication terminal according to claim 2,
wherein
the face authentication terminal is configured to:
when performing face authentication after completing the registration of the biometric public key,
generate the biometric secret key for authentication from the face image for authentication obtained by capturing the face of the person with the camera at a timing when the person is detected by the sensor;
cause the authentication device to perform authentication using the biometric secret key and the registered biometric public key; and
discard, after the authentication device performing the authentication, the biometric secret key for authentication.

13. The face authentication terminal according to claim 1,
wherein
the face authentication terminal is configured to capture the face of the person at the first timing and the second timing to thereby acquire the first face image and the second face image, facial expressions of the person in the first image and the second image being different from each other.

14. A face authentication system comprising a face authentication terminal comprising a sensor including a camera; and an authentication device, the face authentication system being a system in which the face authentication terminal and the authentication device are configured to send and receive information to and from each other,
wherein,
the face authentication terminal is configured to:
generate a first biometric secret key from a first face image, the first face image being one of two face images acquired by capturing a face of a person by the camera at each of a first timing when the person is detected by the sensor and a second timing when the person is detected by the sensor, the second timing being different from the first timing;
generate a second biometric secret key from a second face image, the second face image being the other of the two face images;
generate a biometric public key based on the second biometric secret key; and
transmit the biometric public key to the authentication device to request the authentication device to register the biometric public key; and
the authentication device is configured to:
perform authentication using the first biometric secret key and the biometric public key received from the face authentication terminal to thereby verify whether the authentication is successful; and
complete registration of the biometric public key when it can be verified that the authentication is successful.

15. A face authentication method using a face authentication terminal comprising a sensor including a camera, the face authentication method including:
generating a first biometric secret key from a first face image, the first face image being one of two face images acquired by capturing a face of a person by the camera at each of a first timing when the person is detected by the sensor and a second timing when the person is detected by the sensor, the second timing being different from the first timing;
generating a second biometric secret key from a second face image, the second face image being the other of the two face images;
generating a biometric public key based on the second biometric secret key;
verifying whether authentication is successful using the first biometric secret key and the biometric public key before registering the biometric public key in a key database present inside or outside the face authentication terminal; and
completing registration of the biometric public key in the key database when the authentication can be verified to be successful.
